(19) United States
(12) Patent Application Publication
(10) Pub. No.: US 2025/0033012 A1
(43) Pub. Date: Jan. 30, 2025

(54) REACTION DEVICE FOR A THERMOCHEMICAL REACTOR SYSTEM, AND THERMOCHEMICAL REACTOR SYSTEM

(71) Applicant: DEUTSCHES ZENTRUM FÜR LUFT- UND RAUMFAHRT E.V., Bonn (DE)

(72) Inventors: Stefan BRENDELBERGER, Köln (DE); Fabio PIERNO, Köln (DE)

(73) Assignee: DEUTSCHES ZENTRUM FÜR LUFT- UND RAUMFAHRT E.V., Bonn (DE)

(21) Appl. No.: 18/834,821

(22) PCT Filed: Jan. 27, 2023
(86) PCT No.: PCT/EP2023/052001

§ 371 Date: Jul. 31, 2024

(30) Foreign Application Priority Data
Feb. 2, 2022 (DE) 10 2022 102 456.3

(51) Int. Cl. B01J 8/02

(52) U.S. Cl. CPC B01J 8/025; B01J 8/0285; B01J 2219/00051; B01J 2219/185; B01J 2219/1943; B01J 2219/2404; B01J 2219/2434

(57) ABSTRACT

A reaction device for a thermochemical reactor system, having at least one base device and having at least one solid-medium block. at the at least one solid-medium block is arranged on the base device, and extends along an axial direction with at least one thermochemical reaction material. The least one solid-medium block has at least one shaft that has at least one inlet opening and/or at least one outlet opening.

The present invention relates to a reaction device for a thermochemical reactor system, as well as to a thermochemical reactor system.

It is known to use a redox material for the production of hydrogen or synthesis gas, wherein the redox material is used in redox cycle processes for the splitting of water and CO₂. The redox material is heated for the chemical reaction. In first approaches, heating is performed using solar energy, the redox material absorbing concentrated solar radiation.

According to first concepts, a particulate solid medium is used for the solar production of hydrogen by means of such thermochemical cycle processes. In this process, the solid medium is thermally reduced at high temperatures through a chemical reaction, using solar energy, and is thus activated for the subsequent reaction. Water vapor is supplied thereto at a later time. The medium is oxidized by the oxygen in the water so that hydrogen is produced. In order to continue the cycle process, the oxidized medium has to be reduced again at high temperatures. In the known cycle processes, the particles fall freely through the focal point of the concentrated solar radiation or are moved through the same. Thereafter, the particles are moved into a reactor to carry out the oxidation. Such methods may have the advantage of a continuous process, however, there are problems with respect to the abrasion of the particles, the forming of dust by particle abrasion, and the particle transport.

So-called solid receivers exist, in which the medium is fixedly installed in the receiver and is alternately reduced and oxidized in a batch process. Such receivers cause disadvantages, since the process is not continuous.

Further, a basic problem of the known receivers is a missing or insufficient recuperation of the heat between the reduction step and the oxidation step.

A system is known from DE 10 2018 201 319 A1, in which blocks of redox material are transported through the receiver by means of a conveyor device. Transporting the blocks through the receiver is problematic because of the high temperatures.

Basically, there is a problem that the blocks of thermochemical reaction material, which in part have very high temperatures, have to be transported and must be well adapted to be heated in the framework of a reaction cycle process, wherein further an advantageous reaction with a reaction fluid has to be possible.

Therefore, it is an object of the present invention to provide a reaction device for a thermochemical reactor system with a reaction material, which device is adapted to be heated in an advantageous manner and advantageously enables a reaction with a reaction fluid. It is another object of the present invention to provide a thermochemical reactor system comprising such a reaction device.

The reaction device according to the invention is defined by the features of claim 1. The thermochemical reactor system according to the invention is defined by the features of claim 17.

The reaction device for a thermochemical reactor system comprises at least one base device and at least one solid-medium block, the at least one solid-medium block being arranged on the base device. The at least one solid-medium block extends along an axial direction and consists of a thermochemical reaction material. The at least one solid-medium block comprises at least one shaft with at least one inlet opening and/or at least one outlet opening.

The solid-medium block can be handled in an advantageous manner via the base device, so as to transport the reaction device in a thermochemical reactor system within the framework of a thermochemical cycle process. For this purpose, for example, a transport device can engage the base device.

By providing at least one shaft in the solid-medium block, which has at least one inlet opening and/or at least one outlet opening to the outside, the solid-medium block can be advantageously heated in a thermochemical cycle process and a reaction with a reaction fluid can also take place in an advantageous manner, since not only outer surfaces of the solid medium block are available for a heat exchange and a reaction, but also inwardly directed surfaces, which are formed by the at least one shaft, can be used for the heat exchange and as a reaction surface. The shaft allows solar radiation or thermal radiation, for example, which is used to heat the reaction material, to penetrate deep into the interior of the at least one solid-medium block. Radiation transport along the direction of the shaft results in improved heat exchange. The solid-medium block can be designed as an open-pored body. For example, a reaction fluid can advantageously flow through the solid-medium block via the shaft, the reaction fluid being directed through the shaft into the interior of the solid-medium block and flowing outwards through the pores. By providing at least one inlet opening and/or at least one outlet opening of the at least one shaft, the reaction fluid can flow through all of the solid-medium block, so that a reaction can advantageously take place. This at least one inlet opening and/or at least one outlet opening can also be accessible through a channel in the base device. It may also be provided that the at least one shaft in the solid-medium block has an inlet opening and at least one outlet opening and thus penetrates the solid-medium block.

Preferably, it is provided that the at least one shaft extends in an axial direction and/or in a direction transverse to the axial direction. Depending on the orientation of the shaft, the shaft can be used advantageously for heat transport into the interior of the reaction material or for transport of and reaction with the reaction fluid.

In a particularly preferred embodiment, several shafts are provided which are at least partially connected to each other. In particular, all shafts can be interconnected.

For example, the shafts can have a minimum diameter of their cross section of at least 10 mm. Within the framework of the invention, a shaft is understood as a defined, directional recess formed in the material of the sold-medium block.

In an embodiment with one solid-medium block, it can be provided that a first shaft extends in an axial direction and a plurality of second shafts extends transversal to the axial direction and is connected to the first shaft. Such an embodiment has proven particularly advantageous, since the second shafts extending transverse to the axial direction are advantageously suited for the transport of radiation and fluid into the interior of the shaft, and the first shaft extending in the axial direction is advantageously suited for heat exchange and fluid transport.

In particular, the reaction device according to the invention can provide that a plurality of solid-medium blocks is provided, e.g. at least two solid-medium blocks which are stacked one upon the other in the axial direction, for example. These can be stacked on the base device, so that a kind of tower shape is formed. At least one shaft can be formed in each of the solid-medium blocks. In this way, the reaction device according to the invention can be designed flexibly, since, for example, the number of solid-medium blocks and the design of the solid-medium blocks can be designed flexibly. In addition, simplified production is possible, as the plurality of stackable solid-medium blocks can be smaller in size compared to embodiments with one solid-medium block. It is also possible to replace individual solid-medium blocks if they are damaged.

In principle, it is also possible for a solid-medium block to be composed of several sub-blocks. Such a design can simplify production, as smaller units can be produced which are later assembled.

Also in a design of the reaction device with a plurality solid-medium blocks, it can be provided that a first shaft extends in the axial direction through the plurality of solid-medium blocks and at least one second shaft is arranged in each or in some of the solid-medium blocks, which extends transversely to the axial direction and is connected to the first shaft in each case. In this embodiment, the first shaft, which extends in the axial direction, can also be used advantageously for heat exchange and fluid transport and the second shafts can be used for radiation and fluid transport, for example.

Each of the solid-medium blocks can comprise a centering device for aligning the corresponding solid-medium block with an adjacent solid-medium block. The centering device ensures that the solid-medium blocks are aligned with each other during stacking, so that, for example, the first shaft formed in the solid-medium blocks is aligned accordingly.

The centering device can, for example, form a projection that is adapted to a recess in an adjacent solid-medium block and engages in the recess for alignment with an adjacent solid-medium block. The centering device can, for example, form at least one pin that engages in a corresponding hole in an adjacent solid-medium block. It is also possible for an opening forming the first shaft in a solid medium-block to be surrounded by a protruding collar that engages in a corresponding recess in the adjacent solid-medium block.

Of course, the centering device can also have several projections that engage in corresponding recesses in an adjacent solid-medium block.

It may be provided that a plurality of solid-medium blocks are fastened to each other via a connection device. For example, this may be effected by a screw connection. The connection device provides for a sufficient stability of the reaction device. The connection device can also comprise one or more rods inserted through recesses in the solid-medium blocks to connect the solid-medium blocks.

The solid-medium blocks can have identical or different shapes. The stack of solid-medium blocks can thus be designed flexibly and is, for example, advantageously adaptable to a thermochemical reactor system. For example, the arrangement of solid-medium blocks can be adapted to a heating chamber of the thermochemical reactor system and in particular to a heat or radiation distribution in the heating chamber. The arrangement of the solid-medium blocks may also be adaptable to a reactor, for example, to the flow of reaction fluid in the reactor.

The solid-medium blocks may each have a circular cylindrical or a cylindrical shape with a polygonal cross section. Such shapes are particularly suitable for stacking a plurality of solid-medium blocks one upon the other.

It may be provided that the at least one solid-medium block or the solid-medium blocks are manufactured in a 3D printing process. In this way, optional shapes of the solid-medium blocks can be provided in an advantageous manner.

The at least one solid-medium block or the solid-medium blocks may consist of a porous monolithic material. The material can be of a sponge-like design or have a framework structure. Here, the pore size may, for example, be 5 mm at mots, preferably 2 mm at most. Basically, pores in the material can also be formed in a channel shape, wherein such pores have a narrowest cross section with a maximum diameter of 5 mm, preferably 2 mm, for example. Such a design is advantageous in that radiation penetrating into the pores can be absorbed in an advantageous manner, while at the same time a large surface exists towards the gas chamber, which promotes the exchange between the gas phase and the solid-medium block.

For example, the at least one sold-medium block or the solid-medium blocks can consist of CeO₂, doted CeO₂, Cu₂O/CuO, Mn₃O₄/Mn₂O₃, CoO/Co₃O₄, ferrites (AₓFe₃₋ₓO₄) or perovskites.

Such materials have proven particularly advantageous for thermochemical cycle processes.

In an embodiment with a plurality of solid-medium blocks, it can be provided that the solid-medium blocks are made of different materials. In other words, a solid-medium block can be made of another material than an adjacent solid-medium block. The stack of solid-medium blocks can thus be designed flexibly and is, for example, advantageously adaptable to a thermochemical reactor system. For example, the selection of material for the solid-medium blocks can be adapted to a heating chamber of the thermochemical reactor system and in particular to a heat or radiation distribution in the heating chamber. The selection of material for the solid-medium blocks may also be adaptable to a reactor, for example, to the flow of reaction fluid in the reactor.

The invention may also provide that the base device is made of the same material as the at least one solid-medium block or one of the solid-medium blocks. For example, the base device can also be connected to the at least one solid-medium block or one of the solid-medium blocks with a material bond.

The invention also relates to a thermochemical reactor system with a heating chamber and at least one reactor and with at least one reaction device according to the invention, wherein the at least one reaction device can be heated in the heating chamber and can be supplied for a thermochemical reaction with a reaction fluid in the reactor.

The thermochemical reactor system according to the invention can advantageously perform a thermochemical cycle process, for example a redox cycle process.

For example, the solid-medium block or the solid-medium blocks of the reaction device according to the invention can consist of a redox material.

In the following, the invention is described in more detail with reference to the following Figures. In the Figures:

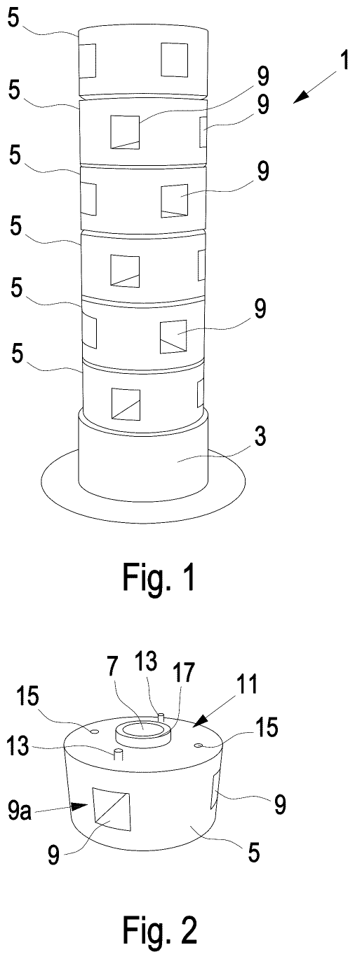

FIG. 1 is a schematic representation of a reaction device according to the invention,

FIG. 2 a schematic detailed representation of a solid-medium block of a reaction device according to the invention, and

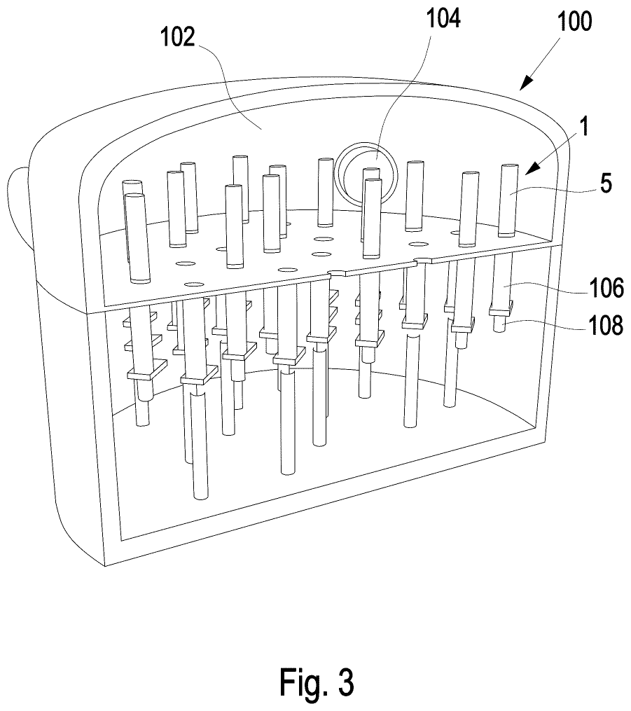

FIG. 3 shows a schematic illustration of a thermochemical reactor system according to the invention.

FIG. 1 shows a schematic representation of a reaction device 1 for a thermochemical reactor system 100 according to the invention.

The reaction device 1 consists of a base device 3 and a plurality of solid-medium blocks 5. The solid-medium blocks 5 are stacked on the base device 3. The solid-medium blocks 5 have a circular cylindrical shape, so that they can be stacked in an advantageous manner. The solid-medium blocks 5 extend along an axial direction.

As best seen in FIG. 2, which schematically shows a solid-medium block 5, the solid-medium blocks 5 each have a central opening forming a first shaft 7 by arranging the solid-medium blocks 5 in series. In a direction transverse to the axial direction, the solid-medium blocks 5 each have a plurality of second shafts 9 which form an inlet opening 9a in the shell surface of the solid-medium blocks 5 and open into the first shaft 7. Thus, the second shafts 9 have an outlet opening towards the first shaft 7. The first shaft 7 and the second shafts 9 ensure that, on the one hand, the thermal energy can be advantageously carried into the interior of the solid-medium blocks 5 when the solid-medium blocks 5 are heated and, on the other hand, a reaction fluid can advantageously flow through the solid-medium blocks 5 during a thermochemical reaction.

For example, when the solid-medium blocks 5 are heated by means of concentrated solar radiation, solar radiation radiated onto the second shafts 9 can advantageously reach the interior of the solid-medium blocks 5. Such radiation transport is also possible in an advantageous manner when heating by means of thermal radiation.

Heat can be advantageously transported through the first shaft 7 via an ambient fluid, so that relatively uniform heating of the solid-medium blocks 5 can be achieved.

Furthermore, during a thermochemical reaction, a reaction fluid can advantageously flow through the solid-medium blocks 5, for example by the reaction fluid flowing through the inlet opening 9a of the second shafts 9 into the interior and then along the first shaft 7.

The solid-medium blocks 5 can also comprise a centering device 11. The centering device 11 can, for example, consist of projections 13 that engage in corresponding recesses 15 of an adjacent solid-medium block 5.

The centering device 11 can also have, for example, a protruding edge around the central opening, which engages in a corresponding annular recess in the adjacent solid-medium block 5 for centering the solid-medium blocks 5 relative to one another.

In addition, adjacent solid-medium blocks 5 can be attached to each other, for example by screw connection, using connection devices not illustrated.

In this way, the reaction device 1 according to the invention can be designed to be stable.

FIG. 3 schematically shows a thermochemical reactor system 100 according to the invention.

The reactor system 100 comprises a heating chamber 102 which can be heated by means of concentrated solar radiation. The concentrated solar radiation can enter the heating chamber 102 via radiation openings 104.

Several reactors 106 are arranged on the heating chamber 102. The reaction devices 1 according to the invention are arranged in the reactors 106. The individual reaction devices 1 can be transported into the heating chamber 102 by means of transport devices 108, by the transport devices 108 lifting the reaction devices 1 so that the solid-medium blocks 5 of the reaction device 1 are located in the heating chamber 102 and can be heated therein.

After the reaction devices 1 have been heated, they can be lowered by means of the transport device 108 so that they are located in the reactor 106. A thermochemical reaction with a reaction fluid can then be performed in the reactor 106.

The solid-medium blocks 5 can be manufactured using 3D printing, for example.

For example, the solid-medium blocks 5 can consist of a porous monolithic material. A porous monolithic material has the advantage that it forms a particularly large surface and a reaction with a reaction fluid can take place in a particularly advantageous way.

List of reference numerals

| | |
|---|---|
| 1 | reaction device |
| 3 | base device |
| 5 | solid-medium block |
| 7 | first shaft |
| 9 | second shaft |
| 9a | inlet opening |
| 11 | centering device |
| 13 | protrusion |
| 15 | recess |
| 100 | reactor system |
| 102 | heating chamber |
| 104 | radiation opening |
| 106 | reactor |
| 108 | transport device |

1-17. (canceled)

18. A reaction device for a thermochemical reactor system, comprising:
at least one base device and having at least one solid-medium block, wherein the at least one solid-medium block is arranged on the base device,
wherein the at least one solid-medium block extends along an axial direction and consists of at least one thermochemical reaction material,
wherein the at least one solid-medium block has at least one shaft that has at least one inlet opening and/or at least one outlet opening.

19. The reaction device according to claim 18, wherein the at least one shaft extends in an axial direction and/or in a direction transverse to the axial direction.

20. The reaction device according to claim 18, wherein a plurality of shafts which are at least partially connected to each other.

21. The reaction device according to claim 20, wherein a first shaft extends in the axial direction and a plurality of second shafts extends transverse to the axial direction and is connected to the first shaft.

22. The reaction device according to claim 18, wherein a plurality of solid-medium blocks stacked one upon the other in the axial direction, with at least one shaft being formed in each of the solid-medium blocks.

23. The reaction device according to claim 22, wherein a first shaft extends in the axial direction through the plurality of solid-medium blocks and at least one second shaft is arranged in each or in some of the solid-medium blocks, which extends transversely to the axial direction and is connected to the first shaft.

24. The reaction device according to claim 18, wherein the at least one solid-medium block or the solid-medium blocks are each formed by a plurality of sub-blocks connected to one another.

25. The reaction device according to claim 22, wherein each solid-medium block has a centering device for aligning a solid-medium block with respect to an adjacent solid-medium block.

26. The reaction device according to claim 25, wherein the centering device has a protrusion adapted to a recess in an adjacent solid-medium block and engages in the recess for alignment with an adjacent solid-medium block.

27. The reaction device according to claim 22, wherein a plurality of solid-medium blocks is fastened to each other via a connection device.

28. The reaction device according to claim 22, wherein the solid-medium blocks have identical or different shapes.

29. The reaction device according to claim 22, wherein the solid-medium blocks are made of identical or different materials.

30. The reaction device according to claim 22, wherein the solid-medium blocks each have a circular cylindrical shape or a cylindrical shape with a polygonal cross section.

31. The reaction device according to claim 18, wherein the at least a solid-medium block or the solid-medium blocks are produced by a 3D printing method.

32. The reaction device according to claim 18, wherein the at least one solid-medium block or the solid-medium blocks is/are formed by a monolithic material.

33. The reaction device according to claim 18, wherein the at least one solid-medium block or the solid-medium blocks consist of CeO₂, doted CeO₂, Cu₂O/CuO, Mn₃O₄/Mn₂O₃, CoO/Co₃O₄, ferrites (AₓFe₃₋ₓO₄) or perovskites.

34. A thermochemical reactor system with a heating chamber and at least one reactor and having at least one reaction device according to claim 18, the at least one reaction device being adapted to be heated in the heating chamber and to be supplied for a thermochemical reaction with a reaction fluid in the reactor.
